(19) United States
(12) Patent Application Publication
(10) Pub. No.: US 2026/0230437 A1
(43) Pub. Date: Aug. 6, 2026

(54) NOISY NEIGHBOR THROTTLING

(71) Applicant: Microsoft Technology Licensing, LLC, Redmond, WA (US)

(72) Inventor: Fernando COLOMBO, Redmond, WA (US)

(21) Appl. No.: 19/046,510

(22) Filed: Feb. 5, 2025

(51) Int. Cl. H04L 47/32

(52) U.S. Cl. CPC H04L 47/32

(57) ABSTRACT

Improved solutions for noisy neighbor throttling (1) ensure that global capacity is not exceeded, (2) allow use of idle resources without a need to specify exceptions, and (3) focus throttling on misbehaving actors (“noise neighbors”) first, while avoiding throttling well-behaved ones. A trigger point is set for initiating throttling for a server, and requests are received from multiple clients. In each timeslot, a total request count and a client-specific request count is determined. The client-specific request counts are sorted in descending order in a list. Efficient single-swap sorting may be used for speed. If the total request count meets the trigger point during a timeslot, the client with the highest request count is readily-identifiable at the top of the sorted list, and that client is throttled. If, while that client is still being throttled, the trigger is hit again and that client still tops the list, the throttling is enhanced.

### BACKGROUND

Multitenant systems share resources between two or more tenants (in which each tenant has one or more clients, or users). Because tenants use the same shared resources, the activity of one tenant may negatively impact another tenant's use of the system. A noisy neighbor problem arises when one tenant's performance is degraded because of the activities of another tenant. The noisy neighbor problem also occurs even when each individual tenant may be consuming moderate amounts of the shared system's capacity, but the collective resource usage of many tenants results in a peak in overall usage that exceeds the shared system's capacity.

Common throttling algorithms for client requests include Token Bucket, Leaky Bucket, and Concurrency Limiter. Unfortunately, these have notable limitations, such as poor protection against overflow and denial of service (DoS) attacks, an inability to allocate idle resources, and an inability to focus throttling on the wort offending noisy neighbors. These algorithms require careful cost measurements and precise load estimates to be effective, and when a situation arises that violates the predictions, such an impactful external event or a historically low-demanding customer starting busy workloads, they either cause excessive or insufficient throttling.

For example, with these common throttling algorithms, even if the service is mostly idle and is able to accommodate more requests from a given low volume client, that client may still be throttled at low pre-defined limits, despite resources still being available. Or, if multiple high-volume clients are active simultaneously, outside predictions, the system will be overwhelmed. This may result in all clients being throttled, including well-behaved clients.

### SUMMARY

The disclosed examples are described in detail below with reference to the accompanying drawing figures listed below. The following summary is provided to illustrate some examples disclosed herein.

Solutions disclosed herein provide for more effective noisy neighbor throttling. Examples identify a trigger point at which to initiate throttling for a server; receive, at the server, requests from a plurality of clients in each time slot of a plurality of time slots; determine, during each time slot of the plurality of time slots, a total request count identifying a count of the requests accepted during the time slot; update a client list with a client request count identifying a count of the requests accepted, from each client of the plurality of clients, during the time slot; and based on at least determining that the total request count meets the trigger point during a first time slot: identify a first client as having a highest client request count of the client list (i.e., identify the first client as a noisy neighbor); and throttle the first client according to an acceptance rate for the first client.

### BRIEF DESCRIPTION OF THE DRAWINGS

The disclosed examples are described in detail below with reference to the accompanying drawing figures listed below:

FIG. 1 illustrates an example architecture that advantageously provides for improved noisy neighbor throttling;

FIGS. 2A and 2B illustrates exemplary noisy neighbor throttling, as may be performed in examples of the architecture of FIG. 1;

FIG. 3 illustrates an exemplary sorted client list, as may be used in examples of the architecture of FIG. 1;

FIG. 4 illustrates alternative exemplary throttled client list, as may be used in examples of the architecture of FIG. 1;

FIG. 5 illustrates an exemplary timeline with time slots and events that may occur in examples of the architecture of FIG. 1;

FIGS. 6 and 7 show flowcharts illustrating exemplary operations that may be performed when using example architectures, such as the architecture of FIG. 1; and

FIG. 8 shows a block diagram of an example computing device suitable for implementing some of the various examples disclosed herein.

Corresponding reference characters indicate corresponding parts throughout the drawings.

### DETAILED DESCRIPTION

Improved solutions for noisy neighbor throttling (1) ensure that global capacity is not exceeded, (2) allow use of idle resources without a need to specify exceptions, and (3) focus throttling on misbehaving actors (“noise neighbors”) first, while avoiding throttling well-behaved ones. A trigger point is set for initiating throttling for a server, and requests are received from multiple clients. In each timeslot, a total request count and a client-specific request count is determined. The client-specific request counts are sorted in descending order in a list. Efficient single-swap sorting may be used for speed. If the total request count meets the trigger point during a timeslot, the client with the highest request count is readily-identifiable at the top of the sorted list, and that client is marked as noisy and throttled. If, while that client is still being throttled, the trigger is hit again and that client still tops the list, the throttling is enhanced. If, however, a different client is at the top of the list, both clients are subject to throttling.

Aspects of the disclosure solve multiple problems that are necessarily rooted in computer technology, and render use of computing platforms more reliable and efficient in highly common use cases, by providing the practical result of improving noisy neighbor throttling. For example, controlling network access by reducing the impact of noisy neighbors is a practical problem that is necessarily rooted in computer technology, and aspects of the disclosure provide improved in at least the three ways previously noted. This significantly improves the use of computers for network operations, such as by preserving performance for well-behaved clients. These advantageous results are accomplished, at least in part, by updating a client list of clients with a client request count identifying a count of requests accepted, from each client of a plurality of clients, during a time slot; identifying, upon a threshold violation, a first client as having a highest client request count of the client list; marking the first client as noisy; and throttling the first client according to an acceptance rate for the first client.

The various examples will be described in detail with reference to the accompanying drawings. Wherever preferable, the same reference numbers will be used throughout the drawings to refer to the same or like parts. References made throughout this disclosure relating to specific examples and implementations are provided solely for illustrative purposes but, unless indicated to the contrary, are not meant to limit all examples.

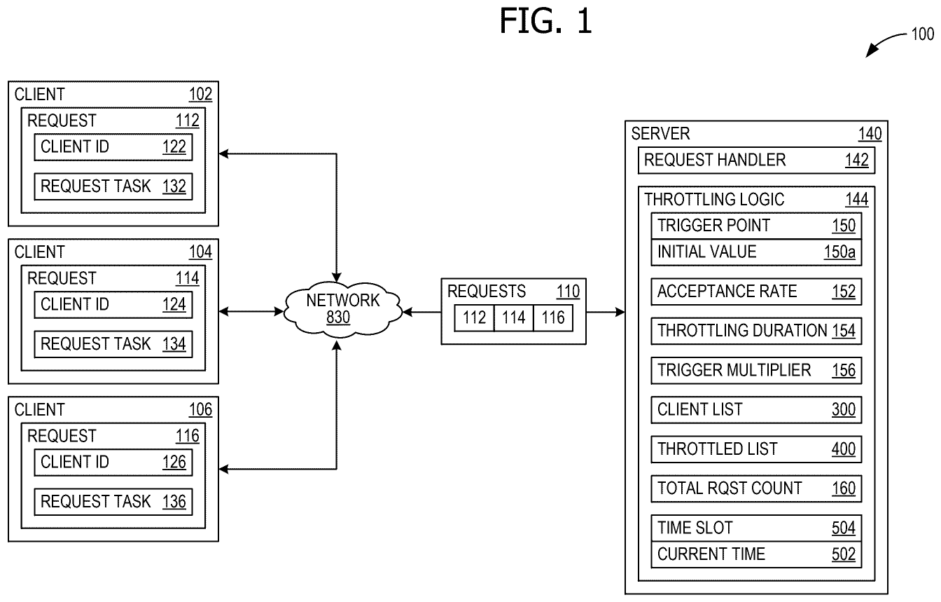

FIG. 1 illustrates an example architecture 100 that advantageously provides for improved noisy neighbor throttling. A set of clients, a client 102, a client 104, and a client 106, each transmits requests to a server 140 over a network 830. The requests include a request 112 from client 102, a request 114 from client 104, and a request 116 from client 106, and are collectively identified as requests 110. Request 112 has a request task 132 and a client identifier (ID) 122 that identifies client 102; request 114 has a request task 134 and a client ID 124 that identifies client 104; and request 116 has a request task 136 and a client ID 126 that identifies client 106.

Each of request tasks 132-136 indicates a task that one of clients 102-106 is requesting server 140 to perform. Although only three clients and three requests are illustrated, it should be understood that a far larger number of clients and requests may by typical. A request is a unit of work that may be accepted or rejected by server 140, and may be a network request, an HTTP request, and a local operation. Examples of the local operations include a read operation, a write operation, a key value update, and a cryptographic operation (e.g., encrypt or decrypt data). A client is an identifiable source of requests, such as subscriber, a user, an application, a tenant, an internet protocol (IP) address, a machine (physical or virtual), or another computing component. A client ID may be a subscriber ID for a multi-user subscriber, a user ID for a single user, an IP address associated with the request, a combination of any two or more of the subscriber ID, the user ID, and the IP address, or any other suitable identifier that associates a request with a particular client.

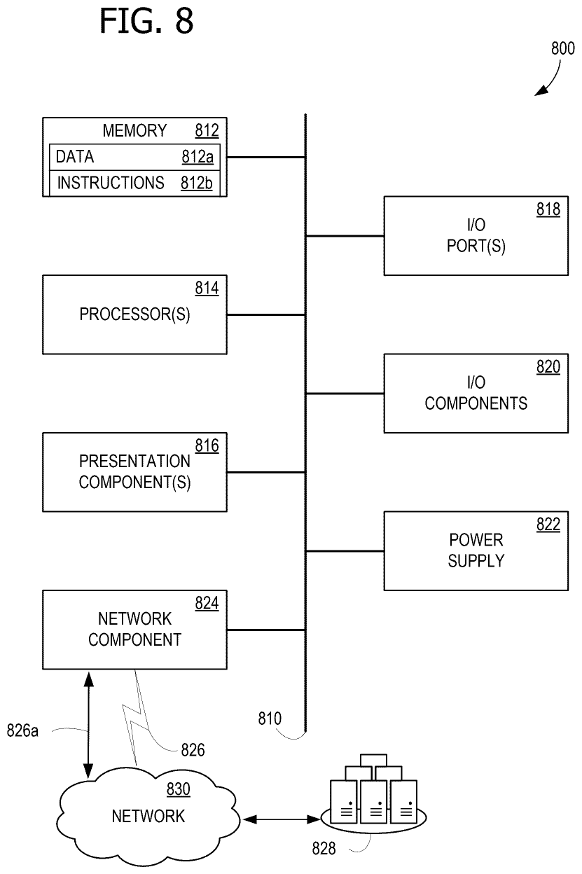

Server 140 may be a computing component, whether a single device or a cluster of computing resources (physical and/or virtual) that takes requests from clients and decides whether to accept or reject each request. Server 140 may be, use, or execute as a virtual machine (VM) on a computing device 800, which is shown in further detail in FIG. 8. If a request is accepted, server 140 allocates further resources (such as CPU, memory, disk and internal network) to process the request. If a request is rejected, server 140 promptly stops working on it, preventing further resource allocation.

In order to preserve performance and resources for well-behaved clients, server 140 throttles traffic (i.e., rejects requests) from misbehaving clients, which are also referred to as noisy neighbors. A noisy neighbor (misbehaving client) is a client that is source of an excessive number of requests to server 140, or that has comparatively high traffic (in terms of the number of requests) in relation to most other clients. A well-behaved client is one that is not a noisy neighbor, i.e., a client that transmits a small or moderate number of requests (i.e., a reasonable traffic load). Throttling is the rejection of requests, for a specific client, in response to that client transmitting too many requests in a particular unit of time, often measured in time slots that are measured on the order of milliseconds (mS).

Throttling may be implemented using an acceptance rate, which is a measure of the probability of an incoming request from a throttled client being accepted. For example, with an acceptance rate of 60%, six out of every ten incoming requests from a throttled client are accepted, and four out of every ten incoming requests from that throttled client are rejected. Selection, from among the incoming requests from the throttled client, for acceptance or rejection may be probabilistic (i.e., random) or deterministic according to some selection algorithm. Throttling may be specified for some duration, after which it is lifted.

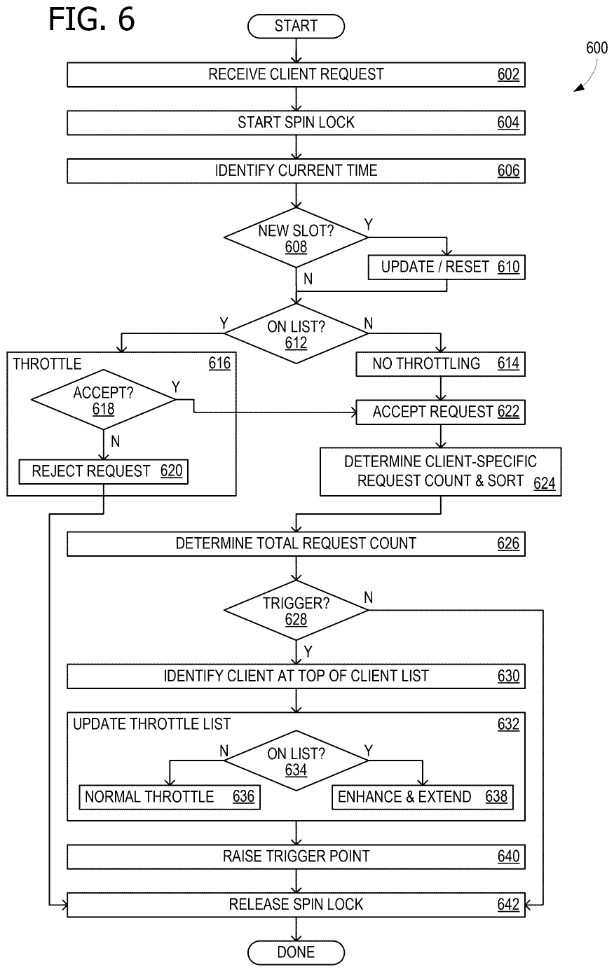

Server 140 has a request handler 142 for handling and processing accepted ones of requests 110, and a throttling logic 144 to handling throttling, when needed. Throttling logic 144 has multiple parameters and data sets, as shown, which include a trigger point 150, an acceptance rate 152, a throttling duration 154, a trigger multiplier 156 by which to increase trigger point 150, a client list 300, a throttled client list 400, and a total request count 160. Throttling logic 144 makes throttling decisions within time slots. A time slot 504, and a current time 502, which is within time slot 504, are shown. The use of time slots is described in further detail in relation to FIG. 5.

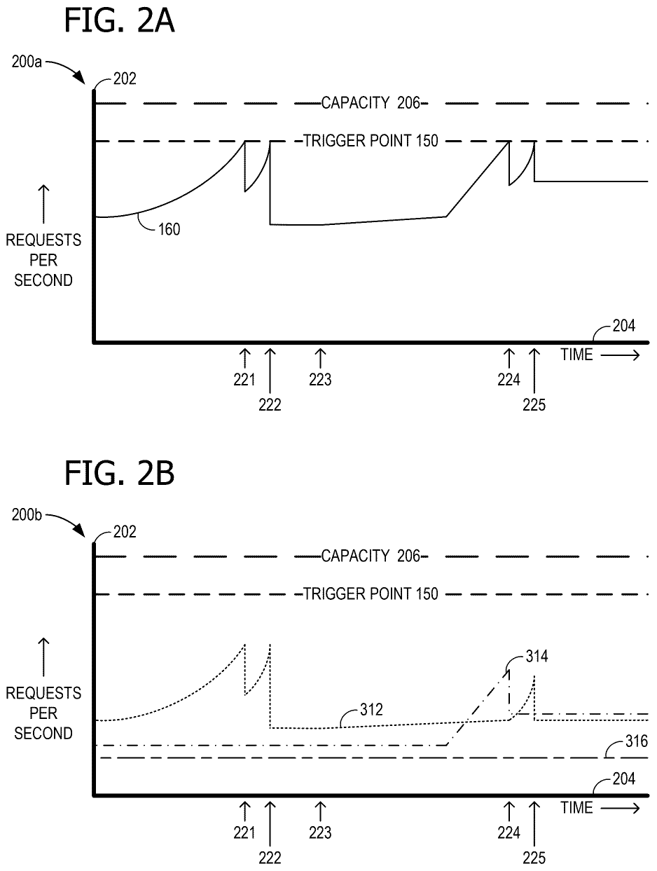

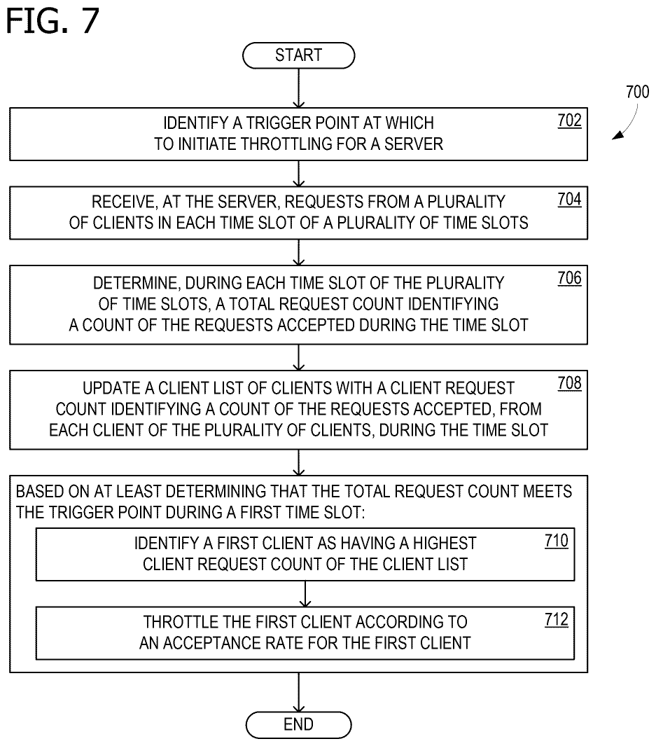

Total request count 160 is the sum of all requests accepted from all clients in the current time slot (e.g., time slot 504). When total request count 160 meets trigger point 150, throttling is applied to the noisiest client, which is identified as described in relation to FIG. 6. Trigger point 150 may typically be set to 50% to 80% of the capacity of server 140 to handle requests without becoming overloaded. This is a server capacity 206, which is shown in FIGS. 2A and 2B. Trigger point 150 has an initial value 150a, but may be increased by applying trigger multiplier 156 as a multiplier during certain periods of exceptionally high traffic, as described in relation to FIG. 6. Typical values for trigger multiplier 156 may range from 1.0 (no increase) to 1.1. When trigger multiplier 156 is 1.05, for example, the increase in trigger point 150 will be 5%.

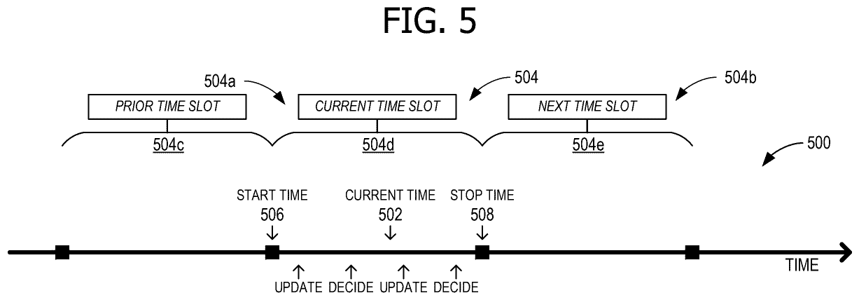

Acceptance rate 152 may have a value of 0.5 to 0.8, with 0.6 or 0.7 being typical. When a client is throttled, the acceptance rate for that client may be initially set to acceptance rate 152. However, if that client persists in being noisy, the acceptance rate for that persistently noisy client can be reduced, such as by multiplying that client's current acceptance rate by acceptance rate 152 each time that persistently noisy client is tagged again during the duration of its throttling. When acceptance rate 152 is 0.7, for example, this can result in an applied acceptance rate, for a particular client, of 0.7 initially, then 0.49 (approximately 50%), and then 0.343, and so forth, reducing each time that client is tagged as being persistently noisy during the time it is being throttled. That is, each client will have its own acceptance rate, which may match acceptance rate 152, or be lower (in some scenarios). This is described in relation to FIGS. 4 and 6.

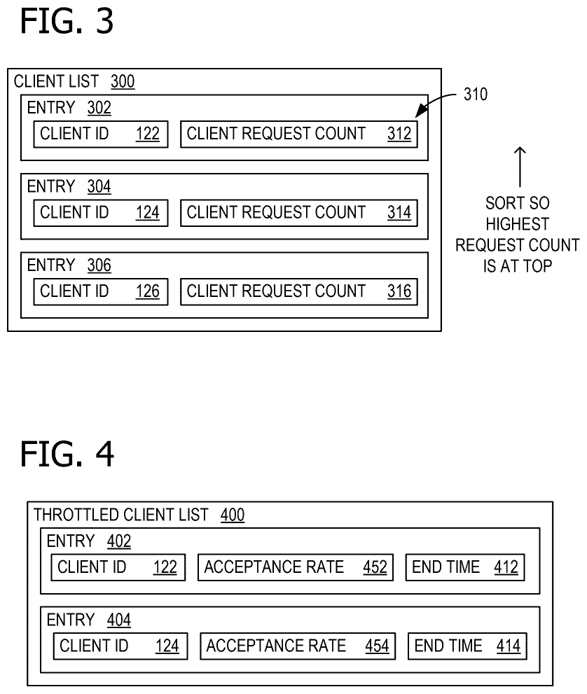

A throttling duration 154 defines the length of time for which throttling is applied to a client, initially, although this may be extended for persistently noisy clients. Throttling duration 154 may have a typical value of 0.5 and 2.0 times the duration of each time slot. Client list 300 is shown in further detail in FIG. 3, and throttled client list 400 is shown in further detail in FIG. 4. This solution causes that, at any given time, zero or more clients have the noisy neighbor mark. At specific times, the noisy neighbor mark is removed for specific clients, ending throttling and restoring request acceptance for those clients.

FIGS. 2A and 2B illustrate a throttling scenario. FIG. 2A shows a plot 200a of total request count 160 graphed against a request count axis 202 as a function of time, with a time axis 204. Server capacity 206 is shown at the top of plot 200a, with trigger point 150 at about 80% of server capacity 206. FIG. 2B shows a plot 200b, also with request count axis 202, time axis 204, server capacity 206, and trigger point 150. FIGS. 2A and 2B should be viewed together.

Total request count 160 is the sum of a client request count 312, a client request count 314, and a client request count 316. Client request count 312 is the count of all requests (e.g., request 112) accepted from client 102 during the current time slot (see FIG. 5). Similarly, client request count 314 is the count of all requests (e.g., request 114) accepted from client 104 during the current time slot, and client request count 316 is the count of all requests (e.g., request 116) accepted from client 106 during the current time slot.

Five notable events are shown in both plots 200a and 200b. At a first event 221, total request count 160 reaches (meets) trigger point 150 as shown in FIG. 2A, and because client request count 312 is the highest (i.e., higher than either client request count 314 or client request count 316) client 102 is throttled. See FIG. 2B. Client 104 and client 106 are both well-behaved clients. How client 102 is identified is described in relation to FIG. 3. Due to the throttling, client request count 312 and total request count 160 both drop substantially.

At a second event 222, total request count 160 again reaches trigger point 150 as shown in FIG. 2A, very shortly after event 221, while client 102 is still being throttled. Because client request count 312 is again the highest (see FIG. 2B), and client 102 is already being throttled, client 102 is even further throttled. This enhanced (further) throttling is described in relation to FIG. 6. Due to the throttling, client request count 312 and total request count 160 both drop substantially. At a third event 223, throttling duration 154 expires, and client 102 is released from throttling. Client request count 312 begins climbing slowly, but client 102 is now a well-behaved client.

At a fourth event 224, total request count 160 again reaches trigger point 150 as shown in FIG. 2A. However, this time, client request count 314 is the highest, so client 104 is throttled. Due to the throttling, client request count 314 and total request count 160 both drop substantially. Shortly thereafter, though, at a fifth event 225, total request count 160 again reaches trigger point 150 as shown in FIG. 2A. Again, it is client 102, as shown by client request count 312 being the highest in FIG. 2B.

This time, though, although client 102 is again selected for throttling, because the prior throttling had expired, client 102 is subject to only the initial throttling rate (i.e., acceptance rate 152), rather than the enhanced throttling that occurred at event 222. Throughout the time period shown in FIGS. 2A and 2B, client 106 remained a well-behaved client, and so was never throttled.

FIG. 3 illustrates further detail for client list 300. Client list 300 has an entry for active clients, which are clients from which a request was received during the current time slot. Client list 300 is emptied at the beginning of each time slot (other than the initial time slot at start-up). As illustrated, client list 300 has three entries. An entry 302 for client 102 has client ID 122 and client request count 312. An entry 304 for client 104 has client ID 124 and client request count 314. An entry 306 for client 106 has client ID 126 and client request count 316.

Client list 300 is sorted as the various client request counts are updated with incoming requests, so that a highest client request count 310 is at the top of client list 300. That is, whichever of client request count 312, client request count 314, and client request count 316 is the highest value will be at the top of client list 300. This enables rapid identification of whichever client is noisiest. For example, this scheme permitted rapid identification of client 102 at events 221, 222, and 225, and rapid identification of client 104 at event 224, in FIGS. 2A and 2B.

In some examples, client list 300 is not fully or entirely sorted, but instead is only “mostly sorted” using single-swap to enhance speed. In single-swap sorting, only a single, recently-updated value, is swapped with a neighbor. For example, if client request count 316, which is shown at the bottom of the list is updated such that it exceeds both client request count 314 and client request count 312, then client request count 316 should be at the top of client list 300. However, with a one-stage single-swap sort, client request count 316 is compared with only client request count 314 (the neighbor immediately above) and swapped with client request count 314 because client request count 316 is the higher value. In this scenario, client request count 312 remains at the top of client list 300, and so client list is not yet fully sorted (with client request count 316 at the top).

After one swap iteration, it is possible that an entry is not in its proper (fully sorted) position. So a second iteration (or stage) of the swap may be performed again at the same time, such as up to some fixed number of times. Some examples may use ten or fewer iterations of swaps. If after these swaps the entry is still not in a sorted position, the swap algorithm stops, leaving the entry in the incorrect position. This is by design, for speed. Because the swap runs multiple times, (e.g., with the various incoming requests) each incoming request moves an entry closer to its proper position. The likelihood of an entry being in the incorrect position when a client needs to be selected for throttling is diminishingly small.

Using a constant number of swap operations per request, the time complexity (CPU cost) of keeping client list 300 sorted is O(1), which enables this approach to be used where high speeds and reduced overhead burden is critical. Additionally, because this scheme has constant time and is fully CPU-bound, a lock may be used (as described in relation to FIG. 5) to maintain synchronization (i.e., prevent a race condition between updating client list 300 and determining the noisiest neighbor), without any operating system (OS) kernel interaction. This further enhances speed.

FIG. 4 illustrates further detail for throttled client list 400. Throttled client list 400 has an entry for clients currently subject to throttling. Throttled client list 400 is updated at the beginning of each time slot, by removing entries for clients whose time for throttling has ended (i.e., expired or concluded). As illustrated, throttled client list 400 has two entries. An entry 402 for client 102 has client ID 122, an acceptance rate 452 for client 102, and an end time 412 for throttling client 102. An entry 404 for client 104 has a client ID 124, an acceptance rate 454 for client 104, and an end time 414 for throttling client 104. Because entries are shown for both client 102 and client 104, this is the configuration of throttled client list 400 that could be expected immediately after event 225 of FIGS. 2A and 2B.

If each client had been throttled anew, both acceptance rate 452 and acceptance rate 454 will equal acceptance rate 152. However, when client 102 is subject to enhanced throttling (e.g., such as at event 222 of FIGS. 2A and 2B), acceptance rate 452 will be lowered to below its initial value of acceptance rate 152, and also lower than acceptance rate 454 for client 104.

FIG. 5 illustrates an exemplary timeline 500 with a time slot 504 and events that may occur during time slot 504. Timeline 500 shows current time 502 within time slot 504, rendering time slot 504 a current time slot 504d. This is also a time slot 504a, which is referenced in the description of FIG. 6. A second time slot 504b, referenced in the description of FIG. 6, is the subsequent time slot, next time slot 504e. A prior time slot 504c preceded current time slot 504d. The roles of current time slot 504d, prior time slot 504c, and next time slot 504e are relative, and current time slot 504d moves such that current time 502 remains within current time slot 504d.

Each time slot has a start time 506 and a stop time 508, and may be one mS to one minute. A time slot may be associated with a timestamp that marks its start time 506. During a single time slot, using time slot 504 for explanation, there may be multiple updates to client list 300, and checks of whether total request count 160 meets trigger point 150. In the example of FIG. 5, there are two iterations of each, although it should be understood that some examples may use different numbers of each operation.

A series of updates and sorts may occur during time slot 504 (current time slot 502d) and the other time slots, interlaced with decisions as to whether to throttle a client, as described below in relation to FIG. 6. These update total request count 160 and also any of client request counts 312-314 for which requests are to be allocated. Client list 300 is thus updated and sorted, during each time slot. A trigger point decision checks whether total request count 160 meets trigger point 150. A lock prevents state corruption from race conditions, such as interlaced sorting operations or interlaced increments of client request counts 312-316. Various types of locks may be used, such as a spinlock, mutex lock, a thread critical section lock, or another mutual exclusion mechanism for multiprocessor or multithreaded systems. For example, a spinlock is a lock that causes a thread trying to acquire it to simply wait in a loop (“spin”) while repeatedly checking whether the lock is available. Since the thread remains active but is not performing a useful task, the use of such a lock is a form of busy waiting. Because they avoid overhead from OS process rescheduling or context switching, spinlocks are efficient if threads are likely to be blocked for only short periods.

FIG. 6 shows a flowchart 600 illustrating exemplary operations that may be performed by architecture 100. In some examples, operations described for flowchart 600 are performed by computing device 800 of FIG. 8. Flowchart 600 describes a process that starts and finishes for throttling logic 144 for each incoming request. In periods in which no request is received, no state change happens for throttling logic 144. An earlier setup process had already identified trigger point 150, at which to initiate throttling for server 140, and also acceptance rate 152, throttling duration 154, and trigger multiplier 156 for use by throttling logic 144.

Flowchart 600 commences with receiving request 112 in operation 602, engaging a lock in operation 604, and identifying current time 502 in operation 606. A decision operation 608 determines whether the time slot has changed to a new time slot. If so, operation 610 performs an update/resetting process. Trigger point 150 returns to initial value 150a (if it had been altered by trigger multiplier 156), client list 300 is cleared, throttled client list 400 is updated to remove clients no longer subject to throttling (i.e., current time 502 is past the end time for a client as identified in throttled client list 400), and total request count 160 client request counts 312-316 are all reset. Flowchart 600 is described with the time slot being current time slot 504a.

Decision operation 612 identifies the associated client using client ID 122 in request 112 and determines whether the request has been received from a client that is on throttled client list 400. If not, then there is no throttling, as shown by box 614. If so, then based on at least current time 502 not yet reaching an end time for throttling that client (e.g., end time 412 for client 102), operation 616 throttles that client according to the acceptance rate for that client (e.g., acceptance rate 452 for client 102). Operation 616 includes decision operation 618, which determines whether the current request (request 112) is accepted. This may be a probabilistic determination, such as using a random number with acceptance rate 452 to determine acceptance.

If decision operation 618 determines to reject request 112, operation 620 rejects request 112. Operation 618 may cause the data packet carrying request 112 to be immediately dropped, or may cause an HTTP response to client 102 indicating that request 112 was not accepted, or cause an error state to be associated with request 112. Neither client request count 312 for client 102, nor total request count 160 is incremented for request 112, in this scenario. There is no triggering, and flowchart 600 then moves to operation 642 to release the lock.

If, however, decision operation 618 determines to accept request 112, or decision operation 612 determined that the client was not throttled, then operation 622 accepts request 112. This may include sending a signal to request handler 142 that request 112 should be fulfilled (processed/executed), or set a flag that will be acted upon by server 140, indicating that request 112 should be fulfilled.

Operation 624 updates client list 300 with the client request count accepted from each client during time slot 504a, which in this specific example is incrementing client request count 312. This includes sorting at least a portion of client list 300 by descending order of the client request counts, such that a client having highest client request count 310 during time slot 504a moves to the top of client list 300. Some examples use single-swap sorting, which does not entirely sort client list 300. In some examples, client list 300 comprises only clients from which a request is received in time slot 504a. Operation 626 determines total request count 160 identifying a count of requests 110 accepted during time slot 504a. This may be accomplished by summing all of client request counts 312-316.

Trigger point decision operation 628 determines whether total request count 160 meets trigger point 150 during time slot 504a. Total request count 160 meets trigger point 150 when total request count 160 equals or exceeds trigger point 150; total request count 160 does not meet trigger point 150 when total request count 160 is below trigger point 150. If total request count 160 does not meet trigger point 150, flowchart 600 moves to operation 642.

If total request count 160 does meet trigger point 150 during time slot 504a, operation 630 identifies which client has having highest client request count 310 of client list 300. In this described example, it is client 102. Thus, client 102 comprises a noisy neighbor or a misbehaving client during time slot 504a. Operation 632 updates throttled client list 400 using operations 634-638.

Decision operation 634 determines whether the client has already been throttled by examining throttled client list 400 and identifying whether the client ID is already listed. If not, normal throttling is applied using operation 636. Operation 636 sets end time 412 for throttling client 102 to current time 502 plus throttling duration 154, and sets acceptance rate 452 to acceptance rate 152. If the client is already on throttled client list 400, operation 638 extends the end time for throttling the client 102 and reduces the acceptance rate for that client (enhancing the throttling). Operation 640 increases trigger point 150 from initial value 150a of trigger point 150, such as by multiplying the current value of trigger point 150 by trigger multiplier 156. Operation 642 releases the lock.

FIG. 7 shows a flowchart 700 illustrating exemplary operations that may be performed by architecture 100. In some examples, operations described for flowchart 700 are performed by computing device 800 of FIG. 8. Flowchart 700 commences with operation 702, which includes identifying a trigger point at which to initiate throttling for a server. Operation 704 includes receiving, at the server, requests from a plurality of clients in each time slot of a plurality of time slots.

Operation 706 includes determining, during each time slot of the plurality of time slots, a total request count identifying a count of the requests accepted during the time slot. Operation 708 includes updating a client list with a client request count identifying a count of the requests accepted, from each client of the plurality of clients, during the time slot. Operations 710 and 712 are both based on at least determining that the total request count meets the trigger point during a first time slot. Operation 710 includes identifying a first client as having a highest client request count of the client list. Operation 712 includes throttling the first client according to an acceptance rate for the first client.

### Additional Examples

An example system comprises: a processor; and a computer-readable medium storing instructions that are operative upon execution by the processor to: identify a trigger point at which to initiate throttling for a server; receive, at the server, requests from a plurality of clients in each time slot of a plurality of time slots; determine, during each time slot of the plurality of time slots, a total request count identifying a count of the requests accepted during the time slot; update a client list with a client request count identifying a count of the requests accepted, from each client of the plurality of clients, during the time slot; and based on at least determining that the total request count meets the trigger point during a first time slot: identify a first client as having a highest client request count of the client list; and throttle the first client according to an acceptance rate for the first client.

An example computer-implemented method comprises: identifying a trigger point at which to initiate throttling for a server; receiving, at the server, requests from a plurality of clients in each time slot of a plurality of time slots; determining, during each time slot of the plurality of time slots, a total request count identifying a count of the requests accepted during the time slot; updating a client list with a client request count identifying a count of the requests accepted, from each client of the plurality of clients, during the time slot; and based on at least determining that the total request count meets the trigger point during a first time slot: identifying a first client as having a highest client request count of the client list; and throttling the first client according to an acceptance rate for the first client.

One or more example computer storage devices have computer-executable instructions stored thereon, which, on execution by a computer, cause the computer to perform operations comprising: identifying a trigger point at which to initiate throttling for a server; receiving, at the server, requests from a plurality of clients in each time slot of a plurality of time slots; determining, during each time slot of the plurality of time slots, a total request count identifying a count of the requests accepted during the time slot; updating a client list with a client request count identifying a count of the requests accepted, from each client of the plurality of clients, during the time slot; and based on at least determining that the total request count meets the trigger point during a first time slot: identifying a first client as having a highest client request count of the client list; and throttling the first client according to an acceptance rate for the first client.

Alternatively, or in addition to the other examples described herein, examples include any combination of the following:
updating a throttled client list identifying each client being throttled, an acceptance rate for the client being throttled, and an end time for throttling the client being throttled;
based on at least a current time not yet reaching the end time for throttling the first client, continuing to throttle the first client;
based on at least the current time being after the end time for throttling the first client, ceasing to throttle the first client;
determining that the total request again meets the trigger point;
identifying the first client as again having the highest client request count of the client list;
based on at least the current time not yet reaching the end time for throttling the first client, extending the end time for throttling the first client;
based on at least the current time not yet reaching the end time for throttling the first client, reducing the acceptance rate for the first client;
extending the end time for throttling the first client comprises resetting the end time to the current time plus the throttling duration;
reducing the acceptance rate for the first client comprises multiplying the current acceptance rate for the first client by an initial value of the acceptance rate;
based on at least the start time for a time slot being after the end time for throttling a client, removing the client from the throttled client list;
identifying the trigger point comprises determining the trigger point based on a server capacity for accepting requests in a time slot;
the trigger point is set at a value of 50% to 80% of the server capacity;
the end time for throttling the first client is set to the current time plus a throttling duration;
the throttling duration ranges between 0.5 and 2.0 times a duration of each time slot;
the acceptance rate for the first client ranges between 0.5 and 0.8;
based on at least determining that the total request count meets the trigger point, increasing the trigger point from an initial value of the trigger point;
based on at least the first time slot ending, returning the trigger point to the initial value, clearing the client list, purging the throttled client list of clients no longer subject to throttling, resetting the total request count, and resetting the client request count for each client;
based on at least the first time slot ending, clearing the client list;
each request comprises a client ID and a request task;
the client identifier comprises an ID selected from the list consisting of: a subscriber ID for a multi-user subscriber, a user ID for a single user, an IP address associated with the request, and a combination of any two or more of the subscriber ID, the user ID, and the IP address;
the request task comprises a task selected from the list consisting of: a network request, an HTTP request, and a local operation;
updating the client list comprises sorting at least a portion of the client list by descending order of the client request counts such that a client having a highest client request count during the time slot moves to a top of the client list;
the sorting comprises single-swap sorting;
the server comprises a cluster of computing resources;
the local operation comprises a task selected from the list consisting of: a read operation, a write operation, a key value update, and a cryptographic operation;
each time slot comprises 1.0 mS to 1.0 minute;
based on at least receiving a request, identifying the client;
based on at least accepting a request, incrementing the client request count for the identified client;
identifying the client request count as a count of the requests accepted from the client during the current time slot;
updating the client list does not require entirely sorting the client list;
the client list comprises only clients from which a request is received in the current time slot;
determining, during the first time slot, that the total request count meets the trigger point;
the total request count meets the trigger point when the total request count equals or exceeds the trigger point;
the total request count does not meet the trigger point when the total request count is below the trigger point;
the first client comprises a noisy neighbor or a misbehaving client during the first time slot;
the first client comprises a well-behaved client, not a noisy neighbor or a misbehaving client, prior to the first time slot;
the throttled client list identifies each client being throttled using the client ID or another identifier uniquely associated with the client ID;
the trigger point is increased within a single time slot by a trigger multiplier of 1.0 to 1.1;
a lock prevents identifying a client as having a highest client request count using the client request count from a prior time slot.

While the aspects of the disclosure have been described in terms of various examples with their associated operations, a person skilled in the art would appreciate that a combination of operations from any number of different examples is also within scope of the aspects of the disclosure.

### Example Operating Environment

FIG. 8 is a block diagram of an example computing device 800 (e.g., a computer storage device) for implementing aspects disclosed herein, and is designated generally as computing device 800. In some examples, one or more computing devices 800 are provided for an on-premises computing solution. In some examples, one or more computing devices 800 are provided as a cloud computing solution. In some examples, a combination of on-premises and cloud computing solutions are used. Computing device 800 is but one example of a suitable computing environment and is not intended to suggest any limitation as to the scope of use or functionality of the examples disclosed herein, whether used singly or as part of a larger set.

Neither should computing device 800 be interpreted as having any dependency or requirement relating to any one or combination of components/modules illustrated. The examples disclosed herein may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples may be practiced in a variety of system configurations, including personal computers, laptops, smart phones, mobile tablets, hand-held devices, consumer electronics, specialty computing devices, etc. The disclosed examples may also be practiced in distributed computing environments when tasks are performed by remote-processing devices that are linked through a communications network.

Computing device 800 includes a bus 810 that directly or indirectly couples the following devices: computer storage memory 812 (i.e., a computer-readable medium), one or more processors 814, one or more presentation components 816, input/output (I/O) ports 818, I/O components 820, a power supply 822, and a network component 824. While computing device 800 is depicted as a seemingly single device, multiple computing devices 800 may work together and share the depicted device resources. For example, memory 812 may be distributed across multiple devices, and processor(s) 814 may be housed with different devices.

Bus 810 represents what may be one or more buses (such as an address bus, data bus, or a combination thereof). Although the various blocks of FIG. 8 are shown with lines for the sake of clarity, delineating various components may be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 8 and the references herein to a “computing device.” Memory 812 may take the form of the computer storage media referenced below and operatively provide storage of computer-readable instructions, data structures, program modules and other data for the computing device 800. In some examples, memory 812 stores one or more of an operating system, a universal application platform, or other program modules and program data. Memory 812 is thus able to store and access data 812a and instructions 812b that are executable by processor 814 and configured to carry out the various operations disclosed herein. Thus, computing device 800 comprises a computer storage device having computer-executable instructions 812b stored thereon.

In some examples, memory 812 includes computer storage media. Memory 812 may include any quantity of memory associated with or accessible by the computing device 800. Memory 812 may be internal to the computing device 800 (as shown in FIG. 8), external to the computing device 800 (not shown), or both (not shown). Additionally, or alternatively, the memory 812 may be distributed across multiple computing devices 800, for example, in a virtualized environment in which instruction processing is carried out on multiple computing devices 800. For the purposes of this disclosure, “computer storage media,” “computer storage memory,” “memory,” and “memory devices” are synonymous terms for the memory 812, and none of these terms include carrier waves or propagating signaling.

Processor(s) 814 may include any quantity of processing units that read data from various entities, such as memory 812 or I/O components 820. Specifically, processor(s) 814 are programmed to execute computer-executable instructions for implementing aspects of the disclosure. The instructions may be performed by the processor, by multiple processors within the computing device 800, or by a processor external to the client computing device 800. In some examples, the processor(s) 814 are programmed to execute instructions such as those illustrated in the flow charts discussed below and depicted in the accompanying drawings. Moreover, in some examples, the processor(s) 814 represents an implementation of analog techniques to perform the operations described herein. For example, the operations may be performed by an analog client computing device 800 and/or a digital client computing device 800. Presentation component(s) 816 present data indications to a user or other device. Exemplary presentation components include a display device, speaker, printing component, vibrating component, etc. One skilled in the art will understand and appreciate that computer data may be presented in a number of ways, such as visually in a graphical user interface (GUI), audibly through speakers, wirelessly between computing devices 800, across a wired connection, or in other ways. I/O ports 818 allow computing device 800 to be logically coupled to other devices including I/O components 820, some of which may be built in. Example I/O components 820 include, for example but without limitation, a microphone, joystick, game pad, satellite dish, scanner, printer, wireless device, etc.

Computing device 800 may operate in a networked environment via the network component 824 using logical connections to one or more remote computers. In some examples, the network component 824 includes a network interface card and/or computer-executable instructions (e.g., a driver) for operating the network interface card. Communication between the computing device 800 and other devices may occur using any protocol or mechanism over any wired or wireless connection. In some examples, network component 824 is operable to communicate data over public, private, or hybrid (public and private) using a transfer protocol, between devices wirelessly using short range communication technologies (e.g., near-field communication (NFC), Bluetooth™ branded communications, or the like), or a combination thereof. Network component 824 communicates over wireless communication link 826 and/or a wired communication link 826a to a remote resource 828 (e.g., a cloud resource) across a computer network 830. Various different examples of communication links 826 and 826a include a wireless connection, a wired connection, and/or a dedicated link, and in some examples, at least a portion is routed through the internet.

Although described in connection with an example computing device 800, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

The order of execution or performance of the operations in examples of the disclosure illustrated and described herein is not essential, and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a processor; and
a computer-readable medium storing instructions that are operative upon execution by the processor to:
identify a trigger point at which to initiate throttling for a server;
receive, at the server, requests from a plurality of clients in each time slot of a plurality of time slots;
determine, during each time slot of the plurality of time slots, a total request count identifying a count of the requests accepted during the time slot;
update a client list with a client request count identifying a count of the requests accepted, from each client of the plurality of clients, during the time slot; and
based on at least determining that the total request count meets the trigger point during a first time slot:
identify a first client as having a highest client request count of the client list; and
throttle the first client according to an acceptance rate for the first client.

2. The system of claim 1, wherein the instructions are further operative to:
update a throttled client list identifying each client being throttled, an acceptance rate for the client being throttled, and an end time for throttling the client being throttled; and
either:
based on at least a current time not yet reaching the end time for throttling the first client, continue to throttle the first client; or
based on at least the current time being after the end time for throttling the first client, cease to throttle the first client.

3. The system of claim 2, wherein the instructions are further operative to:
determine that the total request again meets the trigger point;
identify the first client as again having the highest client request count of the client list; and
based on at least the current time not yet reaching the end time for throttling the first client:
extend the end time for throttling the first client; and/or
reduce the acceptance rate for the first client.

4. The system of claim 3, wherein extending the end time for throttling the first client comprises resetting the end time to the current time plus a throttling duration, and/or wherein reducing the acceptance rate for the first client comprises multiplying a current value of the acceptance rate by an initial value of the acceptance rate.

5. The system of claim 1, wherein the instructions are further operative to:
based on at least determining that the total request count meets the trigger point, increase the trigger point from an initial value of the trigger point; and
based on at least the first time slot ending, return the trigger point to the initial value.

6. The system of claim 1,
wherein each request comprises a client identifier (ID) and a request task;
wherein the client identifier comprises an ID selected from the list consisting of:
a subscriber ID for a multi-user subscriber, a user ID for a single user, an internet protocol (IP) address associated with the request, and a combination of any two or more of the subscriber ID, the user ID, and the IP address; and
wherein the request task comprises a task selected from the list consisting of:
a network request, an HTTP request, and a local operation.

7. A computer-implemented method comprising:
identifying a trigger point at which to initiate throttling for a server;
receiving, at the server, requests from a plurality of clients in each time slot of a plurality of time slots;
determining, during each time slot of the plurality of time slots, a total request count identifying a count of the requests accepted during the time slot;
updating a client list with a client request count identifying a count of the requests accepted, from each client of the plurality of clients, during the time slot; and
based on at least determining that the total request count meets the trigger point during a first time slot:
identifying a first client as having a highest client request count of the client list; and
throttling the first client according to an acceptance rate for the first client.

8. The computerized method of claim 7, further comprising:
updating a throttled client list identifying each client being throttled, an acceptance rate for the client being throttled, and an end time for throttling the client being throttled; and
either:
based on at least a current time not yet reaching the end time for throttling the first client, continuing to throttle the first client; or
based on at least the current time being after the end time for throttling the first client, ceasing to throttle the first client.

9. The computerized method of claim 8, further comprising:
determining that the total request again meets the trigger point;
identifying the first client as again having the highest client request count of the client list; and
based on at least the current time not yet reaching the end time for throttling the first client:
extending the end time for throttling the first client; and/or
reducing the acceptance rate for the first client.

10. The computerized method of claim 9, wherein extending the end time for throttling the first client comprises resetting the end time to the current time plus a throttling duration, and/or wherein reducing the acceptance rate for the first client comprises multiplying a current value of the acceptance rate by an initial value of the acceptance rate.

11. The computerized method of claim 8, further comprising:
based on at least a start time for a time slot being after the end time for throttling a client, removing the client from the throttled client list.

12. The computerized method of claim 8,
wherein identifying the trigger point comprises determining the trigger point based on a server capacity for accepting requests in a time slot;
wherein the trigger point is set at a value of 50% to 80% of the server capacity;
wherein the end time for throttling the first client is set to the current time plus a throttling duration;
wherein the throttling duration ranges between 0.5 and 2.0 times a duration of each time slot; and
wherein the acceptance rate for the first client ranges between 0.5 and 0.8.

13. The computerized method of claim 7, further comprising:
based on at least determining that the total request count meets the trigger point, increasing the trigger point from an initial value of the trigger point; and
based on at least the first time slot ending, returning the trigger point to the initial value.

14. The computerized method of claim 7,
wherein each request comprises a client identifier (ID) and a request task;
wherein the client identifier comprises an ID selected from the list consisting of:
a subscriber ID for a multi-user subscriber, a user ID for a single user, an internet protocol (IP) address associated with the request, and a combination of any two or more of the subscriber ID, the user ID, and the IP address; and
wherein the request task comprises a task selected from the list consisting of:
a network request, an HTTP request, and a local operation.

15. The computerized method of claim 7, wherein updating the client list comprises sorting at least a portion of the client list by descending order of the client request counts such that a client having a highest client request count during the time slot moves to a top of the client list.

16. The computerized method of claim 15, wherein the sorting comprises single-swap sorting.

17. A computer storage device having computer-executable instructions stored thereon, which, on execution by a computer, cause the computer to perform operations comprising:
identifying a trigger point at which to initiate throttling for a server;
receiving, at the server, requests from a plurality of clients in each time slot of a plurality of time slots;
determining, during each time slot of the plurality of time slots, a total request count identifying a count of the requests accepted during the time slot;
updating a client list with a client request count identifying a count of the requests accepted, from each client of the plurality of clients, during the time slot; and
based on at least determining that the total request count meets the trigger point during a first time slot:
identifying a first client as having a highest client request count of the client list; and
throttling the first client according to an acceptance rate for the first client.

18. The computer storage device of claim 17, wherein the operations further comprise:
updating a throttled client list identifying each client being throttled, an acceptance rate for the client being throttled, and an end time for throttling the client being throttled; and
either:
based on at least a current time not yet reaching the end time for throttling the first client, continuing to throttle the first client; or
based on at least the current time being after the end time for throttling the first client, ceasing to throttle the first client.

19. The computer storage device of claim 18, wherein the operations further comprise:
determining that the total request again meets the trigger point;
identifying the first client as again having the highest client request count of the client list; and
based on at least the current time not yet reaching the end time for throttling the first client:
extending the end time for throttling the first client; and/or
reducing the acceptance rate for the first client.

20. The computer storage device of claim 19, wherein extending the end time for throttling the first client comprises resetting the end time to the current time plus a throttling duration, and/or wherein reducing the acceptance rate for the first client comprises multiplying a current value of the acceptance rate by an initial value of the acceptance rate.
